(19) United States
(12) Patent Application Publication
(10) Pub. No.: US 2017/0287016 A1
(43) Pub. Date: Oct. 5, 2017

(54) PERSONALIZED MARKETING AND ADVERTISING SYSTEM AND METHOD

(71) Applicant: Karl SCHMIDT, Massillon, OH (US)

(72) Inventor: Karl SCHMIDT, Massillon, OH (US)

(21) Appl. No.: 15/086,889

(22) Filed: Mar. 31, 2016

(51) Int. Cl. G06Q 30/02

(52) U.S. Cl. CPC G06Q 30/0271

(57) ABSTRACT

A personalized marketing and advertising system is provided. The system sets it apart from competitors' approaches by utilizing marketing material that incorporates at least one buying image of the recipient's previous buying experience, thereby urging them to become a return purchaser.

### BACKGROUND OF THE INVENTION

The present invention relates to marketing and advertising and, more particularly, to a personalized marketing and advertising system and method thereof.

Typically, business customers feel that the companies they buy from only follow up with them by mail and email in a very generic, non-personalized manner. The played out nature of the current, so-called personalized marketing and advertising approaches is self frustrating, as recipients of such “personalized” marketing and advertising are immediately turned off, treating it as the junk mail and spam email that it is.

As can be seen, there is a need for a personalized marketing and advertising system that sets itself apart from competitors' approaches by utilizing marketing material that incorporates at least one buying image of the recipient's previous buying experience, thereby urging them to become a return purchaser.

### SUMMARY OF THE INVENTION

In one aspect of the present invention, a method of personalizing marketing includes capturing at least one buyer image of at least one buyer partaking in a buying experience; incorporating the at least one buyer image into at least one marketing material; and delivering the at least one marketing material to the at least one buyer.

In another aspect of the present invention, a system for personalizing marketing material includes a computer having a user interface; and a program product having machine-readable program code for causing, when executed, the computer to perform the following process steps: receiving at least one buyer image of at least one buyer partaking in a buying experience; incorporating the at least one buyer image into at least one marketing material; and delivering the at least one marketing material to the at least one buyer.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention, demonstrating use;

FIG. 2 is a schematic view of an exemplary embodiment of the present invention, illustrating marketing material, such as a screen shot of digital touch points;

FIG. 3 is a schematic view of an exemplary embodiment of the present invention, illustrating marketing material, such as a front of a post card; and

FIG. 4 is a schematic view of an exemplary embodiment of the present invention, illustrating marketing material, such as a back of the post card.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a personalized marketing and advertising system that sets it apart from competitors approaches by utilizes marketing material that incorporates at least one buying image of the recipient's previous buying experience, thereby urging them to become a return purchaser.

Steve Jobs once said: “You've got to start with the customer experience and work back to the technology—not the other way around.”

Customer experience is the product of an interaction between an organization and a customer over the duration of their relationship. This interaction includes a customer's attraction, awareness, discovery, cultivation, advocacy and purchase and use of a good or service. It is measured by the individual's experience during all points of contact against the individual's expectations. And, accordingly, the buying experience is the most important thing in sales and marketing. In other words, the buying experience includes everything buyers perceive during the experience of buying a product or service, as they move from status quo to purchase, moving from buyer to a purchaser, and hopefully to repeat purchaser.

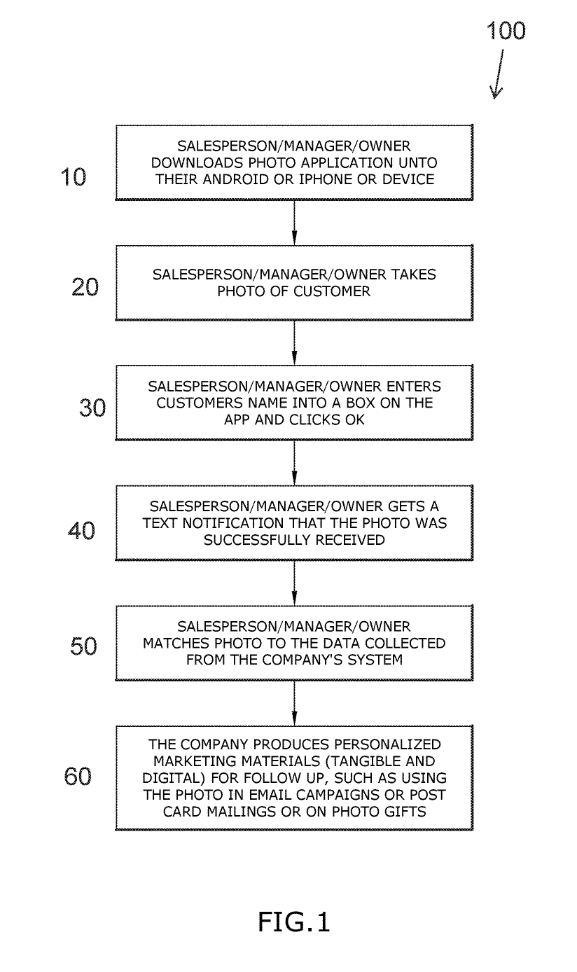

Referring to FIG. 1, the present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention may include a personalized marketing and advertising system 100. The personalized marketing and advertising system 100 may include an imagining device including, but not limited to, a digital camera of the computer or another computer device such as a smart-phone, tablet, that is otherwise electronically connectable to the relevant software application, for example, an iPhone, android or the like photo app for capturing photographed images.

The imagining device may be adapted to capture a photographed image or representative image of an individual partaking in the buying experience (“buying image”), wherein the buying image is exportable to the relevant software application. The relevant software application may be adapted to incorporate these and other buying images into marketing material.

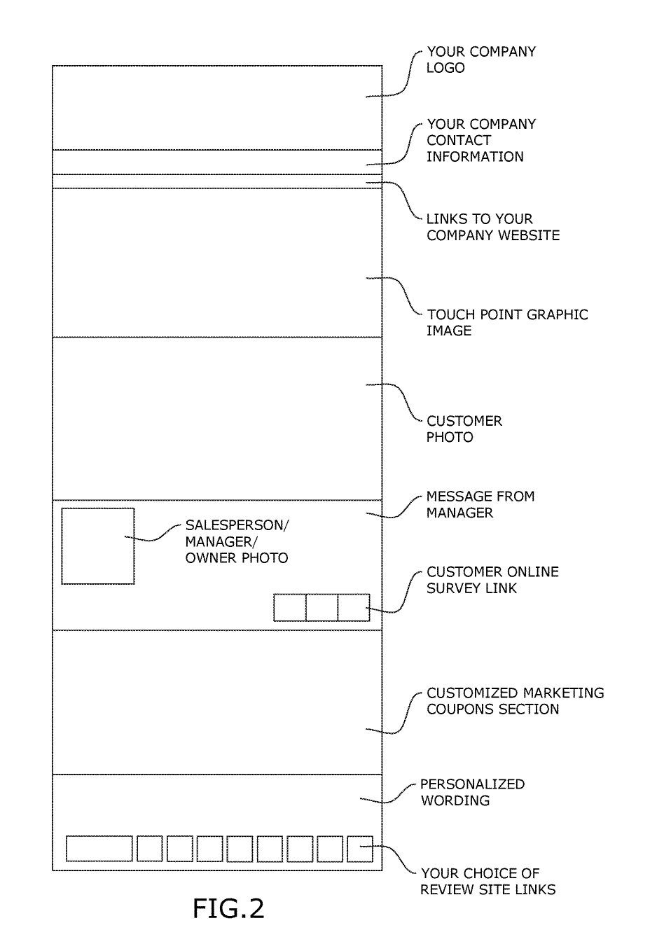

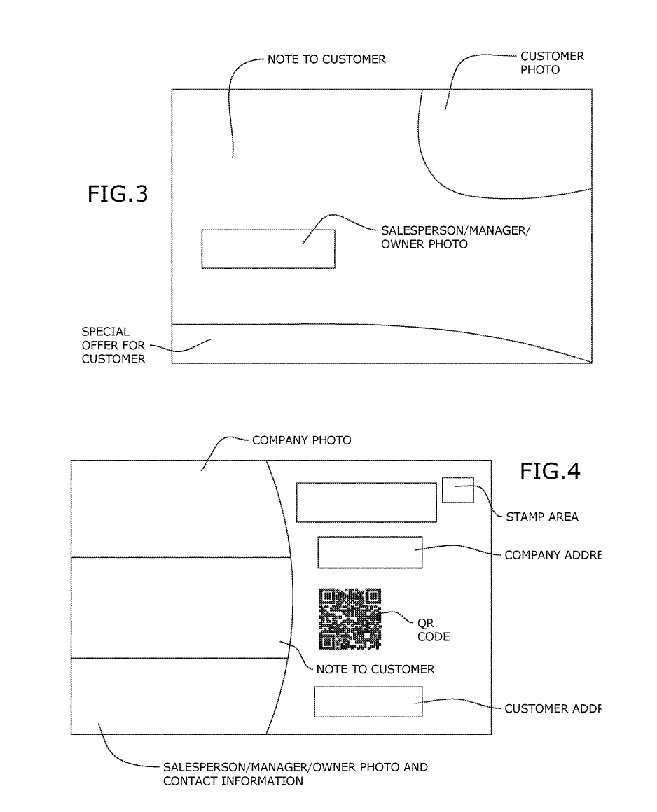

Referring to FIGS. 2 through 4, marketing material may include but not be limited to physical and digital forms, such as post cards, glossy brochures, newsletters, photo gifts, direct mail campaign, emails, video and/or audio output, and the like.

The buying experience includes those experiences mentioned above, as well as at least the information that the buyer will consume during the process, for example online reviews, and any interactions the buyer has during the process of making a prospective purchase, including interactions with a seller, brands, peers, journalists, analysts, and the like. The term seller may include salesperson, manager, owner, business entity, organization, and the like offering a buying experience.

The personalized marketing and advertising system 100 may include a database adapted to retrievably store buying images and information pertaining to the buying experience. The information pertaining to the buying experience may include buyers' names, phone numbers, email addresses, mailing addresses, and place, date, time, quantity, and quality of associated purchases.

In certain embodiments, the personalized marketing and advertising system 100 may interconnect the imagining device, database and an automated email platform that would incorporate the buying image(s) in marketing material that would be electronically delivered to buyers. The personalized marketing and advertising system 100 may include hardware to produce, print or otherwise incorporate buying images into physical marketing material, such as post cards, in a specifiable location therein, along with the buyer's name and address and the advertising elements the company wanted to include.

In certain embodiments, the seller would be issued a unique password to open the personalized marketing and advertising system 100 and relevant software that would only work for their organization. Each organization may be associated or assigned to a portion of data base, which only they can access.

The method embodied in the personalized marketing and advertising system 100 may include the following steps. In step 10, a seller downloads the imagining device and relevant software to an associated computer. In step 20, the seller uses the imaging device to capture a buying image of at least one buyer partaking in a buying experience. In step 30 the seller enters information pertaining to the buying experience into the relevant software application and electronically confirms completion thereof. In step 40, the seller receives an electronic notification that the at least one buying image and associated information pertaining to the buying experience have been retrievably stored in the database. In step 50, the seller electronically confirms the association between the at least one buying image and the information pertaining to the buying experience. In step 60, the seller produces marketing material incorporating the at least one buying image and then sending it to the buyer to urge them to become a repeat purchaser.

As way of example only, the present invention may capture at least one buying image of a buyer purchasing an automobile at a car dealership. The at least one buying image will them be incorporated in marketing materials targeting said buyer, urging them to make a future purchase at the car dealership or associated seller.

The captured buying image starts everything. In certain embodiments, the buyer may be prompted, during the buying experience, to capture their own buying image and input prompted-for information pertaining to the buying experience.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of personalizing marketing, comprising:
capturing at least one buyer image of at least one buyer partaking in a buying experience;
incorporating the at least one buyer image into at least one marketing material; and
delivering the at least one marketing material to the at least one buyer.

2. The method of claim 1, further comprising the step of associating information pertaining to the buying experience with the at least one buyer.

3. The method of claim 2, further comprising the step of incorporating at least a portion of the information pertaining to the buying experience into the at least one marketing material.

4. The method of claim 1, further comprising the step of providing an imagining device configured to capture the at least one buyer image.

5. A system for personalizing marketing material, comprising:
a computer having a user interface; and
a program product comprising machine-readable program code for causing, when executed, the computer to perform the following process steps:
receiving at least one buyer image of at least one buyer partaking in a buying experience;
incorporating the at least one buyer image into at least one marketing material; and
delivering the at least one marketing material to the at least one buyer.

6. The system of claim 5, wherein the marketing material and the delivery thereof is electronic or digital.

7. The system of claim 5, further comprising:
prompting a user to associate information pertaining to the buying experience with the at least one buyer;
receiving the information pertaining to the buying experience; and
incorporating at least a portion of the information pertaining to the buying experience into the at least one marketing material.

8. The system of claim 5, further comprising electronically connecting an imagining device to the computer, wherein the imaging device is configured to capture the at least one buyer image.

9. The system of claim 5, further comprising transmitting an electronic confirmation to a user that the at least one buyer image was received.
